(19) United States
(12) Patent Application Publication
(10) Pub. No.: US 2021/0024768 A1
(43) Pub. Date: Jan. 28, 2021

(54) PRINTED FILM, PRINTING METHOD, INK SET, AND PRINTING APPARATUS

(71) Applicant: SEIKO EPSON CORPORATION, Tokyo (JP)

(72) Inventors: Satoshi KIMURA, Fujimi (JP); Masahiro YATAKE, Shiojiri (JP); Haruko TERAO, Fujimi (JP); Mitsuhiro WADA, Matsumoto (JP)

(21) Appl. No.: 17/040,489

(22) PCT Filed: Dec. 18, 2018
(86) PCT No.: PCT/JP2018/046602

§ 371 Date: Sep. 22, 2020

(30) Foreign Application Priority Data
Mar. 23, 2018 (JP) 2018-056072

(51) Int. Cl. C09D 11/54; C09D 11/322; C09D 11/107; B41M 5/00

(52) U.S. Cl. CPC C09D 11/54; C09D 11/322; B41M 5/0023; B41M 5/0011; C09D 11/107

(57) ABSTRACT

There are provided a printed film having an increased wet rub resistance and a printing method, an ink set, and a printing apparatus that can increase the wet rub resistance.

The printed film is formed on the surface of a non-water-absorbent or slightly water-absorbent printing medium and contains an organic solvent. The printed film satisfies the following relationship (A):

5≤I_{A}/I_{MAX}≤10 (A).

In the relationship, I_{MAX} is the maximum intensity of the secondary ions derived from the organic solvent, measured in the thickness direction from the uppermost surface of the printed film by time-of-flight secondary ion mass spectrometry (TOF-SIMS); and I_{A} is the average intensity of the secondary ions derived from the organic solvent measured in the thickness direction from the uppermost surface of the printed film by time-of-flight secondary ion mass spectrometry (TOF-SIMS) in a period between 0.05×T_{MAX} and 0.50×T_{MAX} after the start of the measurement, wherein T_{MAX} represents the flight time of the secondary ions when the intensity of the secondary ions reaches Iₘₐₓ.

This application is a U.S. National Phase application of International Application No. PCT/JP2018/046602, filed on Dec. 18, 2019 which claims priority to Japanese Patent Application No. 2018-056072, filed on Mar. 23, 2018. The entire disclosures of the above applications are expressly incorporated by reference herein.

### BACKGROUND

### Technical Field

The present invention relates to a printed film, a printing method, an ink set, and a printing apparatus.

### Related Art

It has been studied to improve the rub resistance and other properties of printed films formed by applying ink onto a plastic film or any other non-water-absorbent film.

For example, Japanese Unexamined Patent Application Publication No. 2016-169370 discloses that printed films formed by applying an ink containing water, an organic solvent, a specific compound, and at least two types of resin particles onto a non-water-absorbent substrate exhibit improved properties including rub resistance.

However, the known printed films, as well as those disclosed in Japanese Unexamined Patent Application Publication No. 2016-169370, are required to have further improved resistance to rubbing, particularly, to wet rubbing.

Accordingly, the present invention is intended to overcome the above issue, and it is an object of the present invention to provide a printed film having an improved resistance to wet rubbing and a printed method, an ink set, and a printing apparatus that can increase the resistance to wet rubbing.

### SUMMARY

The present inventors found, through their intensive research for overcoming the above issue, that printed films formed on a surface of a non-water-absorbent printed medium and containing an organic solvent can have high resistance to wet rubbing when the films satisfy specific conditions, having reached the present invention.

The present invention is embodied as follows:

(1)

A printed film formed on a surface of a non-water-absorbent or slightly water-absorbent printing medium and containing an organic solvent,

the printed film satisfying the following relationship (A):

5≤I_{MAX}/I_{A}≤10 (A)

where

I_{MAX}: maximum intensity of the secondary ions derived from the organic solvent, measured in the thickness direction from the uppermost surface of the printed film by time-of-flight secondary ion mass spectrometry (TOF-SIMS); and

I_{A}: average intensity of the secondary ions derived from the organic solvent measured in the thickness direction from the uppermost surface of the printed film by time-of-flight secondary ion mass spectrometry (TOF-SIMS) in a period between 0.05×T_{MAX} and 0.50×T_{MAX} after the start of the measurement, wherein T_{MAX} represents the flight time of the secondary ions when the intensity of the secondary ions reaches Iₘₐₓ.

(2)

The printed film of (1), wherein the non-water absorbent or slightly water-absorbent printing medium contains polypropylene as a main constituent.

(3)

The printed film of (1) or (2), containing a urethane resin.

(4)

The printed film of any one of (1) to (3), containing an amino-containing polymer containing an amino group.

(5)

The printed film of (4), wherein the amino-containing polymer is polyethyleneimine.

(6)

The printed film of any one of (1) to (5), wherein the organic solvent is soluble in water.

(7)

A printing method including a pretreatment step of applying a treatment liquid containing an amino-containing polymer containing an amino group onto a non-water-absorbent or slightly water-absorbent printing medium,

an ejection step of ejecting an ink composition containing an organic solvent, a coloring material, and a resin onto the printing medium having the treatment liquid applied thereto, and

a drying step of drying the printing medium having received the ink composition.

(8)

An ink set used for forming the printed film of any one of (1) to (6),

the ink set including a treatment liquid containing an amino-containing polymer containing an amino group and an ink composition containing an organic solvent, a coloring material, and a resin.

(9)

A printing apparatus used in the printing method of (7),

the printing apparatus including an ejection device configured to eject the ink composition.

### BRIEF DESCRIPTION OF THE DRAWINGS

FIG. 1 is a flow chart of an exemplary printing method of the present invention.

FIG. 2 is a schematic diagram of an exemplary printing apparatus of the present invention.

FIG. 3 is a profile obtained by a TOF-SIMS measurement of the printed film of Example 1.

FIG. 4 is a profile obtained by a TOF-SIMS measurement of the printed film of Comparative Example 1.

### DETAILED DESCRIPTION

The implementation of the present invention will now be described (using some embodiments of the present invention). However, the invention is not limited to the disclosed embodiments, and various modifications may be made without departing from the scope and spirit of the invention.

### Printing Method

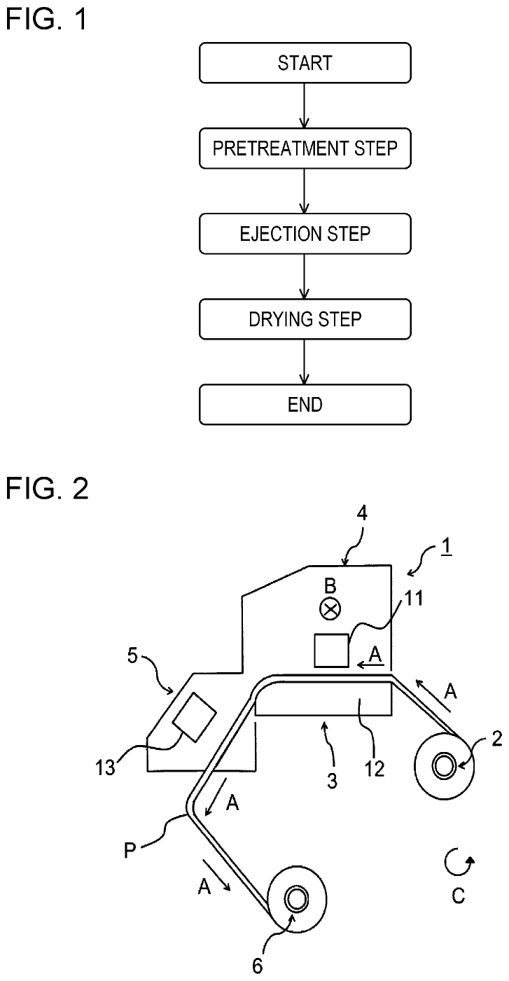

The printed method according to any of the embodiments of the present invention includes a pretreatment step of applying a treatment liquid containing an amino-containing polymer containing an amino group onto a non-water-absorbent or slightly water-absorbent printing medium, an ejection step of ejecting an ink composition containing an organic solvent, a coloring material, and a resin onto the printing medium having the treatment liquid applied thereto, and a drying step of drying the printing medium having received the ink composition. FIG. 1 is a flow chart of the printing method according to an embodiment of the present invention. In the printing method of any embodiment of the invention, the resistance to wet rubbing, or wet rub resistance, of the printed film is increased through the steps mentioned above. The present inventors assume that the reason why the wet rub resistance of the printed film is increased is as described below but is not necessarily limited to the following reasons. In general, when the ink composition is ejected to a non-water-absorbent or slightly water-absorbent printing medium, organic solvent often remains to some extent in the resulting printed film even after drying. A part of such residual solvent is present together with a resin in the surface layer of the printed film. The residual solvent and the resin in the surface layer are likely to ionize when coming into contact with water, consequently degrading the wet rub resistance of the printed film. In the printing method of any embodiment of the invention, in particular, a treatment liquid containing an amino-containing polymer containing an amino group is applied onto a non-water-absorbent or slightly water-absorbent printing medium in the pretreatment step. The treatment liquid causes the amino-containing polymer to react with the resin and organic solvent in the ink composition to form a network structure, thus bringing the printed film into a stable condition, that is, a state in which the organic solvent is unlikely to ionize. On drying the printed film in such a stable condition, the resin and the organic solvent in the printed film, which are stable at the interface between the printed film and the printing medium, become unlikely to migrate. Since the organic solvent does not much migrate from the interface to the surface layer of the printed film, the residual organic solvent in the surface layer, which is likely to ionize when coming into contact with water, decreases much compared to the case of not performing the pretreatment step. Thus, the printing method is expected to increase the wet rub resistance of the printed film.

### Pretreatment Step

The pretreatment step of the printing method of any embodiment of the invention is a step of applying a treatment liquid containing an amino-containing polymer containing an amino group onto a non-water-absorbent or slightly water-absorbent printing medium.

### Non-Water-Absorbent or Slightly Water-Absorbent Printing Medium

The non-water-absorbent or slightly water-absorbent printing medium may be, for example, a printing medium mainly containing polyolefin resin or a printing medium mainly containing polyester resin. The polyolefin resin may be polypropylene. Polypropylene is superior in tensile strength, workability, moisture proofing, and transparency and is therefore used as inexpensive moisture-proofing food packaging material for rice crackers, dried food, vegetables, or the like. Polypropylene does not contain polar groups, which have the feature to increase adhesion, and is, therefore, not suitable for increasing the adhesion of the printed film to ensure a rub resistance. The phrase “mainly containing” or “mainly contain” used herein implies that the subject concerned may contain additives to control some properties or functions, such as an antioxidant, a plasticizer, an antistatic, and a lubricant, in addition to the main constituent.

### Treatment Liquid

The treatment liquid used in the pretreatment step contains, for example, an amino-containing polymer containing an amino group and a solvent.

Examples of the amino-containing polymer include poly(vinyl amine), poly(allylamine), polyacrylamide, and polyethyleneimine. Such amino-containing polymers may be used individually or in combination. From the viewpoint of further increasing the wet rub resistance, polyethyleneimine is preferable to other amino-containing polymers.

The number average molecular weight of the amino-containing polymer is, for example, from 100 to 1,000,000. Preferably, it is 1,000 to 500,000, more preferably 10,000 to 100,0000, from the viewpoint of producing the advantageous effects of the present invention more effectively and reliably. The number average molecular weight can be determined by, for example, a known method of viscosity measurement.

The amine value of the amino-containing polymer is, for example, from 1 mmol to 100 mmol per gram of solid. Preferably, it is 5 mmol to 50 mmol per gram of solid, more preferably 10 mmol to 30 mmol per gram of solid, from the viewpoint of producing the advantageous effects of the present invention more effectively and reliably. The amine value can be determined by titration in a non-aqueous system.

The solvent is a substance in which the amino-containing polymer can dissolve or disperse and is not otherwise limited. Examples of the solvent include water; alcohols, such as methanol, ethanol, propanol, isopropanol, butanol, propylene glycol, and 1,3-butanediol; esters, such as ethyl acetate, butyl acetate, and γ-butyrolactone; ethers, such as diethyl ether and tetrahydrofuran; and hydrocarbons, such as toluene, hexane, cyclohexane, benzene, and octane. Such solvents may be used individually or in combination. From the viewpoint of more sufficiently dissolving or dispersing the amine-containing polymer, water and/or one or more alcohols are preferably selected from those solvents, and water is more preferred.

The amino-containing polymer content in the treatment liquid is, for example, 0.1 mass % to 10 mass % in terms of solid content relative to the total mass of the treatment liquid. Preferably, it is 0.3 mass % to 5 mass %, more preferably, 0.5 mass % to 1.0 mass %, from the viewpoint of producing the advantageous effects of the present invention more effectively and reliably.

### Application of Treatment Liquid

The application of the treatment liquid to the non-water-absorbent or slightly water-absorbent printing medium may be performed by, for example, pad printing, coating, spraying, or an ink jet method.

### Ejection Step

In the printing method of any embodiment of the invention, the ejection step is a step of ejecting an ink composition containing an organic solvent, a coloring material, and a resin onto the printing medium having the treatment liquid applied thereto.

### Ink Composition

The ink composition contains a coloring material, a resin, and an organic solvent. The ink composition may further contain a surfactant and water.

### Coloring Material

The coloring material may be a dye or a pigment and is preferably a pigment.

The pigment may be an organic pigment or an inorganic pigment. Examples of the organic pigment include azo pigments, such as azo lake pigments, insoluble azo pigments, condensed azo pigments, and chelate azo pigments; polycyclic pigments, such as phthalocyanine pigments, perylene pigments, perinone pigments, anthraquinone pigments, quinacridone pigments, dioxazine pigments, thioindigo pigments, isoindolinone pigments, isoindoline pigments, quinophthalone pigments, and diketopyrrolopyrrole pigments; dye lake pigments, such as basic dye lakes and acid dye lakes; nitro pigments; nitroso pigments; aniline black; and daylight fluorescent pigments. Examples of the inorganic pigment include metal oxides, such as titanium dioxide, zinc oxide, and chromium oxide, and carbon black. Such pigments may be used individually or in combination.

Pigments for magenta ink or red ink include, for example, C. I. (Colour Index Generic Name) Pigment 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 177, C. I. Pigment Red 179, C. I. Pigment Red 224, C. I. Pigment Red 254, C. I. Pigment Violet 19, and C. I. Pigment Violet 23.

Pigments for orange or yellow ink include, for example, C. I. Pigment Orange 31, C. I. Pigment Orange 43, C. I. Pigment Orange 64, C. I. Pigment Orange 71, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 109, C. I. Pigment Yellow 128, C. I. Pigment Yellow 138, C. I. Pigment Yellow 150, C. I. Pigment Yellow 155, and C. I. Pigment Yellow 180.

Pigments for green or cyan ink include, for example, C. I. Pigment Blue 15, C. I. Pigment Blue 15:2, C. I. Pigment Blue 15:3, C. I. Pigment Blue 15:4, C. I. Pigment Blue 16, C. I. Pigment Blue 60, C. I. Pigment Green 7, and C. I. Pigment Green 36.

Pigments for black ink include, for example, C. I. Pigment Black 7 (carbon black), C. I. Pigment Black 11, and C. I. Pigment Black 1.

Pigments for white ink include, for example, C. I. Pigment White 6, C. I. Pigment White 18, and C. I. Pigment White 21.

The coloring material content may be, for example, 1% to 30% relative to the total mass of the ink composition.

When a pigment is added as the coloring material, the pigment may be surface-treated to increase the dispersibility thereof in the ink. For example, a hydrophilic group, such as carboxy or sulfo, may be physically or chemically introduced to the surfaces of the pigment particles.

### Resin

Examples of the resin include acrylic resin, styrene-acrylic resin, fluorene resin, urethane resin, polyolefin resin, rosin-modified resin, terpene resin, polyester resin, polyamide resin, epoxy resin, vinyl chloride resin, vinyl chloride-vinyl acetate copolymer, and ethylene-vinyl acetate copolymer. Such resins may be used individually or in combination. Preferably, the resin is a urethane resin. The use of urethane resin easily ensures adhesion.

The urethane resin may be a polyether-type urethane resin having an ether bond as well as the urethane bond in the backbone, a polyester-type urethane resin having an ester bond as well as the urethane bond in the backbone, or a polycarbonate-type urethane resin having a carbonate linkage as well as the urethane bond in the backbone. Such urethane resins may be used individually or in combination.

Preferably, the urethane resin has an anionic functional group, such as carboxy, sulfo, or hydroxy, from the viewpoint of increasing the storage stability of the ink composition.

The urethane resin is preferably in the form of an emulsion from the viewpoint of further reducing viscosity. The emulsion may an emulsion-polymerized, a forcibly emulsified, or a self-emulsified urethane resin.

The resin content may be, for example, 0.5% to 5% relative to the total mass of the ink composition.

### Organic Solvent

The organic solvent may be selected from among, but not limited to, 2-pyrrolidone and derivatives thereof, 1,2-alkanediols, and polyhydric alcohols. Such organic solvents may be used individually or in combination.

Examples of 2-pyrrolidone and derivatives thereof include 2-pyrrolidone, N-methyl-2-pyrrolidone, N-ethyl-2-pyrrolidone, and N-vinyl-2-pyrrolidone.

The content of 2-pyrrolidone or a derivative thereof may be 1.0% to 20% relative to the total mass of the ink composition.

Examples of the 1,2-alkanediols include 1,2-propanediol, 1,2-butanediol, 1,2-pentanediol, 1,2-hexanediol, and 1,2-octanediol.

The 1,2-alkanediol content may be 1.0% to 10% relative to the total mass of the ink composition.

Examples of the polyhydric alcohols include ethylene glycol, diethylene glycol, triethylene glycol, propylene glycol, dipropylene glycol, 1,3-propanediol, 1,3-butanediol, 1,3-pentanediol, 1,4-butanediol, 1,5-pentanediol, 1,6-hexanediol, 2,3-butanediol, 3-methyl-1,3-butanediol, 3-methyl-1,5-pentanediol, 2-methyl-1,3-propanediol, 2,2-dimethyl-1,3-propanediol, 2-methyl-2,4-pentanediol, trimethylolpropane, and glycerin.

Preferably, the polyhydric alcohol content is 5.0% to 20% relative to the total mass of the ink composition.

### Surfactant

The surfactant may be an acetylene glycol-based surfactant, a silicone surfactant, or a fluorosurfactant.

Examples of the acetylene glycol-based surfactant include, but are not limited to, Surfynol series 104, 104E, 104H, 104A, 104BC, 104DPM, 104PA, 104PG-50, 104S, 420, 440, 465, 485, SE, SE-F, 504, 61, DF 37, CT 111, CT 121, CT 131, CT 136, TG, GA, and DF110D (all produced by Air Products and Chemicals, Inc.); Olfine series B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all produced by Nissin Chemical Industry); and Acetylenol series E00, E00P, E40, and E100 (all produced by Kawaken Fine Chemicals).

The silicone surfactant is preferably, but is not limited to, a polysiloxane-based compound. The polysiloxane-based compound may be, but is not limited to, a polyether-modified organosiloxane. Polyether-modified organosiloxanes are commercially available, and examples thereof include BYK-306, BYK-307, BYK-333, BYK-341, BYK-345, BYK-346, and BYK-348 (all produced by BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical).

The fluorosurfactant may be, for example, BYK-340 (produced by BYK).

The surfactant content may be 1.0% 5.0% relative to the total mass of the ink composition.

### Water

The water may be pure water or ultrapure water, such as ion-exchanged water, ultrafiltered water, reverse osmotic water, or distilled water.

The water content may be 30% to 80% relative to the total mass of the ink composition.

### Ejection of Ink Composition

The ink composition is ejected, for example, by an ink jet method onto the printing medium having the treatment liquid applied thereto. Ink jet methods include, but are not limited to, thermal ink jet, piezoelectric ink jet, continuous ink jet, roller application, and spray application.

### Drying Step

In the drying step, the printing medium that has received the ink jet composition is dried. The heating temperature for drying is not particularly limited and may be, for example, 60° C. to 150° C. Preferably, it is 70° C. to 90° C. The heating time may be, but is not limited to, about 5 min to 30 min.

### Printed Film

The printed film according to any of the embodiments of the invention is formed on the surface of a non-water-absorbent or slightly water-absorbent printing medium and contains an organic solvent. The printed film satisfies the following relationship (A):

5≤I_{MAX}/I_{A}≤10 (A)

where

I_{MAX}: the maximum intensity of the secondary ions derived from the organic solvent, measured in the thickness direction from the uppermost surface of the printed film by time-of-flight secondary ion mass spectrometry (TOF-SIMS); and

I_{A}: the average intensity of the secondary ions derived from the organic solvent measured in the thickness direction from the uppermost surface of the printed film by time-of-flight secondary ion mass spectrometry (TOF-SIMS) in a period between 0.05×T_{MAX} and 0.50×T_{MAX} after the start of the measurement, wherein T_{MAX} represents the flight time of the secondary ions when the intensity of the secondary ions reaches Iₘₐₓ.

In any embodiment of the present invention, by making the printed film satisfy relationship (A), the wet rub resistance of the printed film is increased. The reason for this is probably as described below but is not limited to the following reasons. A printed film satisfying relationship (A) implies that the amount of the residual organic solvent in the surface layer of the printed film is smaller than that in the entire printed film. When the amount of the residual organic solvent in the surface layer is less than that in the entire printed film, the strength of the printed film against water does not much decrease even if the printed film comes into contact with water that is likely to ionize the organic solvent in an unstable condition. Thus, the wet rub resistance of the printed film is increased.

In order for the printed film to satisfy relationship (A), the treatment liquid containing an amino-containing polymer containing an amino group is applied onto a non-water-absorbent or slightly water-absorbent printing medium before ejecting the ink composition to the non-water-absorbent or slightly water-absorbent printing medium, for example, as in the printing method of an embodiment of the present invention.

A specific method of TOF-SIMS will now be described. Ions that can be used as the primary ion for TOF-SIMS include metal ions, such as Au⁺, In⁺, Bi⁺, and Ga⁺, and the secondary ions to be detected are selected from a secondary ion mass spectrum of multivalent metals obtained by a preliminary measurement. The primary ion is accelerated by a voltage of 20 kV to 30 kV, and the beam diameter of the ion, measured by a knife-edge method, may be adjusted to 0.25 μm or less. The irradiation conditions, such as beam current, and the irradiation time may be arbitrary. A region in which the entire printed film can be measured may be irradiated with the primary ion beam. An image of the residual organic solvent present in the printed film can be formed by using the positions irradiated with the primary ion beam and the secondary ions detected. More specifically, the image of the residual organic solvent is obtained by recording targeted secondary ions selected from a secondary ion mass spectrum measured at 256×256 points in the irradiated region. For obtaining the image and the profile of a sample, in general, a function of the data processing software of the secondary ion mass spectrometer is used.

In relationship (A), I_{MAX}/I_{A} is preferably 5.5 to 9.5, more preferably 6 to 9, from the viewpoint of further increasing the wet rub resistance.

### Non-Water-Absorbent or Slightly Water-Absorbent Printing Medium

The term non-water-absorbent or slightly water-absorbent printing medium refers to a printing medium that is not provided with an aqueous ink-receiving layer or a printing medium whose aqueous ink-receiving layer is poor. Such a printing medium may be, for example, a printing medium mainly containing polyolefin resin or a printing medium mainly containing a polyester resin.

### Amino-Containing Polymer

Preferably, the printed film contains an amino-containing polymer containing an amino group from the viewpoint of further increasing the wet rub resistance.

Examples of the amino-containing polymer include poly(vinyl amine), poly(allylamine), polyacrylamide, and polyethyleneimine. Such amino-containing polymers may be used individually or in combination. From the viewpoint of still further increasing the wet rub resistance, polyethyleneimine is preferable to other amino-containing polymers.

The number average molecular weight of the amino-containing polymer is, for example, from 100 to 1,000,000. Preferably, it is 1,000 to 500,000, more preferably 10,000 to 100,0000, from the viewpoint of producing the advantageous effects of the present invention more effectively and reliably. The number average molecular weight can be determined by, for example, a known method of viscosity measurement.

The amine value of the amino-containing polymer is, for example, from 1 mmol to 100 mmol per gram of solid. Preferably, it is 5 mmol to 50 mmol per gram of solid, more preferably 10 mmol to 30 mmol per gram of solid, from the viewpoint of producing the advantageous effects of the present invention more effectively and reliably. The amine value can be determined by titration in a non-aqueous system.

The amino-containing polymer content in the printed film may be, for example, 5% to 50% relative to the total mass of the printed film.

### Urethane Resin

Preferably, the printed film contains a urethane resin. The urethane resin may be a polyether-type urethane resin having an ether bond as well as the urethane bond in the backbone, a polyester-type urethane resin having an ester bond as well as the urethane bond in the backbone, or a polycarbonate-type urethane resin having a carbonate linkage as well as the urethane bond in the backbone. Such urethane resins may be used individually or in combination. Preferably, the urethane resin has an anionic functional group, such as carboxy, sulfo, or hydroxy, from the viewpoint of increasing the storage stability of the ink composition.

The urethane resin content in the printed film may be, for example, 5% to 50% relative to the total mass of the printed film.

### Further Resins

The printed film may further contain any other polymer or resin apart from the amino-containing polymer and the urethane resin. Resins that may be further added to the printed film include acrylic resin, styrene-acrylic resin, fluorene resin, polyolefin resin, rosin-modified resin, terpene resin, polyester resin, polyamide resin, epoxy resin, vinyl chloride resin, vinyl chloride-vinyl acetate copolymer, and ethylene-vinyl acetate copolymer. Such resins may be used individually or in combination.

### Coloring Material

The printed film may contain a coloring material. The coloring material may be, for example, selected from those presented in the Printing Method section. The coloring material may be an individual substance or a combination of two or more substances.

The coloring material content in the printed film may be, for example, 5% to 50% relative to the total mass of the printed film.

### Organic Solvent

The printed film inevitably contains a trace amount of organic solvent. Such organic solvents include, for example, those presented in the section of [printing method]. In view of high wet rub resistance, the organic solvent is preferably a water-soluble organic solvent.

The organic solvent content in the printed film may be, for example, 100 ppm or less relative to the total mass of the printed film.

### Ink Set

The ink set according to any of the embodiments of the invention is used for forming the printed film disclosed herein and includes a treatment liquid containing an amino-containing polymer containing an amino group and an ink composition containing an organic solvent, a coloring material, and a resin. The treatment liquid may be that described in the Printing Method section, and the ink composition may be that described in the Printing Method section.

### Printing Apparatus

The printing apparatus according to any of the embodiments of the invention is used in the printing method disclosed herein and includes an ejection device operable to eject the ink composition. The ink jet apparatus may be an ink jet printer including an ink jet head from which the ink composition is ejected. The printing apparatus of an embodiment of the present invention may include a drying device to dry the printing medium that has received the ink composition.

FIG. 2 is a schematic side view of a printing apparatus according to an embodiment of the present invention. The printing apparatus 1 of an embodiment of the present invention includes a loading section 2 in which a roll of a printing medium P is set, a feeding section 3 operable to feed the printing medium P in a feeding direction A, a printing section 4 that is disposed upstream in the feeding direction A and operable to print the printing medium P with the ink composition, a drying section 5 that is disposed downstream in the feeding direction A and operable to dry the printing medium P printed with the ink composition, and a take-up section 6 that is disposed further downstream in the feeding direction A and operable to rotate in a rotating direction C to wind the dried printing medium P therearound for collection. The printing apparatus according to any of the embodiments of the invention is not limited to the structure depicted in FIG. 2, provided that the ink composition can be ejected from an ink jet head. For example, the printing apparatus of an embodiment is not necessarily provided with the drying section 5 as a drying mechanism.

### Loading Section 2

The loading section 2 rotates in the rotational direction C when the feeding section 3 advances the printing medium P in the feeding direction A.

### Feeding Section 3

The feeding section 3 includes a plurality of feed rollers (not shown) with which the printing medium P advances in the feeding direction A.

### Printing Section 4

The printing section 4 includes a printing head 11 and a platen 12 disposed opposite the printing head 11 to support a portion of the printing medium P. The printing head 11 has an ink container (not shown) adapted to contain an ink composition of an embodiment of the present invention and a plurality of nozzle openings (not shown). The printing head 11 ejects the ink composition through the nozzle openings onto the portion of the printing medium P supported on the platen 12 and opposing the printing head 11, thus printing the medium P. The printing is performed by reciprocally moving the printing head 11 across the printing medium P in a scanning direction B intersecting the feeding direction A.

### Drying Section 5

The drying section 5 includes a heater 13 capable of emitting electromagnetic waves (for example, infrared radiation) for heating. The heater 13 can dry the printing medium P printed with the ink composition.

### Take-Up Section 6

The take-up section 6 rotates in the rotational direction C to wind the printing medium P therearound.

An embodiment of the printing method using the printing apparatus 1 depicted in FIG. 2 will now be described. First, a roll of a printing medium P is set in the loading section 2. Then, the printing medium P is fed to the printing section 4 by the feeding section 3 advancing the printing medium P in the feeding direction A. The printing head 11 ejects the ink composition from the ink container through the plurality of nozzle openings onto the portion of the printing medium P supported on the platen 12 and opposing the printing head 11, thus printing the medium. The printing is performed by reciprocally moving the printing head 11 across the printing medium P in a scanning direction B intersecting the feeding direction A. Next, the printing medium P printed with the ink composition is fed to the drying section by the feeding section 3 and dried by the heater 13 of the drying section 5. The printing medium P dried by heating is wound around the take-up section 6, thus collected.

In an embodiment of the ink jet printer, one or more desired components or elements may be added to the printing apparatus 1 depicted in FIG. 2.

### EXAMPLES

The implementation of the present invention will be further described with reference to specific examples but is not limited to the disclosed examples.

### Materials Used

The following materials were used in the following Examples and Comparative Examples.

### Resin Emulsion

Mowinyl 972 (product name, produced by Nippon Synthetic Chemical Industry, solid content: 50%)

### Pigment

Pigment Blue 15:3

### Surfactant

BYK-348 (product name, produced by BYK)

### Water

Pure water

### Preparation of Pigment Dispersion Liquid

The pigment was dispersed according to the following procedure. A water-soluble resin solution was prepared by dissolving 40 parts by mass of a dispersant resin (copolymer of methacrylic acid, butyl acrylate, styrene, and hydroxyethyl acrylate in a proportion by mass of 25:50:15:10, weight average molecular weight: 12,000) in a mixture of 7 parts of potassium hydroxide, 23 parts by mass of water, and 30 parts by mass of triethylene glycol mono-n-butyl ether with stirring and heating at 80° C. To 1.75 kg of the resulting water-soluble resin solution (solid content: 43%) were added 3.0 kg of the above-presented pigment, 1.5 kg of ethylene glycol, and 8.75 kg of water. The materials were pre-mixed by being agitated with a mixing machine. The resulting pigment mixture was further agitated for dispersion by a multi-pulse technique in a bead mill having an effective volume of 1.5 L, 85% charged with 0.5 mm zirconia beads, equipped with a multi-disk impeller. More specifically, the pigment mixture was agitated two passes at a bead peripheral speed of 8 m/s and a discharge rate of 30 L/h, and thus a pigment-mixed liquid was prepared. Subsequently, the pigment-mixed liquid was subjected to circulation dispersion in an annular bead mill having an effective volume of 1.5 L, 95% charged with 0.05 mm zirconia beads. For this operation, 10 kg of the pigment-mixed liquid was circulated for 4 hours, using a 0.015 mm pore screen, at a bead peripheral speed of 10 m/s and a circulation rate of 300 L/h. Thus, a pigment dispersion liquid containing 20% of solid pigment was prepared.

### Preparation of Ink Compositions

The constituents with contents presented in Table 1 (the values in the Table were represented by percentage to the total mass of the composition) were mixed and stirred for 2 hours, and the mixture was filtered through a 5 μm pore membrane filter. Thus, ink compositions A and B were prepared.

TABLE 1

| | | Ink composition A | Ink composition B |
|---|---|---|---|
| Pigment dispersion liquid | | 10 | 10 |
| Urethane resin emulsion | | 4 | 4 |
| Solvent | 2-Pyrrolidone | 19 | 3.5 |
| | 1,2-Hexanediol | 6 | 4.5 |
| | Dipropylene glycol | 11 | — |
| | Propylene glycol | — | 13 |

| | | |
|---|---|---|
| Surfactant | 0.5 | 0.5 |
| Water | Balance | Balance |

### Example 1

After an OPP film (a product “FOS-AQ grade” manufactured by Futamura Chemical Co., Ltd.) was treated with ultraviolet light to impart hydrophilicity, a treatment liquid was applied onto the OPP film with a 20 μm-thick coating bar coater to yield a treatment liquid-coated OPP film (pretreatment step). The treatment liquid was prepared by diluting a polyethyleneimine aqueous solution (0.75 mass % aqueous solution of “EPOMIN (registered trademark) P-1000” produced by Nippon Shokubai Co., Ltd.) to 30 times with water. Then, ink composition A presented in Table 1 was ejected onto the treatment liquid-coated OPP film from an ink jet printer (“PX-G930” manufactured by Seiko Epson Corporation) (ejection step). At this time, the platen temperature was 55° C. for ejection. Next, the OPP film that had received ink composition A was dried at a heating temperature of 90° C. for 10 minutes in an oven (drying step). Thus, a printed film was formed.

### Example 2

A printed film was formed in the same manner as in Example 1, except for changing the drying temperature from 90° C. to 70° C. in the drying step.

### Example 3

A printed film was formed in the same manner as in Example 1, except that ink composition B made up of the constituents with contents presented in Table 1 was ejected in the ejection step, instead of composition A.

### Example 4

A printed film was formed in the same manner as in Example 3, except for changing the drying temperature from 90° C. to 70° C. in the drying step.

### Comparative Example 1

A printed film was formed in the same manner as in Example 1, except that ink composition A made up of the constituents with contents presented in Table 1 was ejected in the ejection step onto an OPP film (a product “FOS-AQ grade” manufactured by Futamura Chemical Co., Ltd.) that was not subjected to the pretreatment step.

### Comparative Example 2

A printed film was formed in the same manner as in Example 2, except that ink composition B made up of the constituents with contents presented in Table 1 was ejected in the ejection step onto an OPP film (a product “FOS-AQ grade” manufactured by Futamura Chemical Co., Ltd.) that was not subjected to the pretreatment step.

### TOF-SIMS Measurement

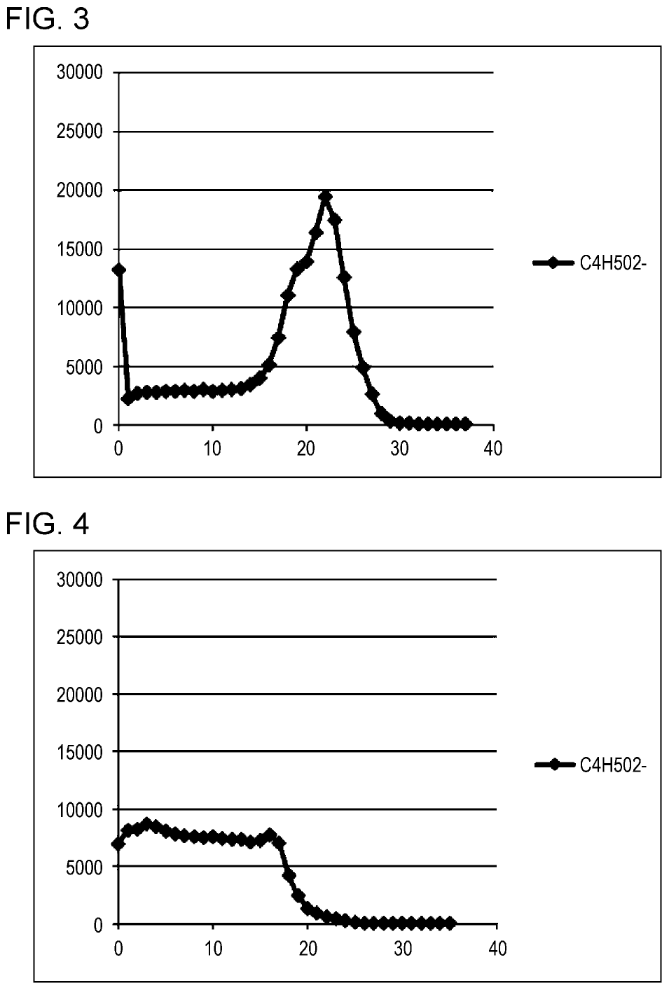

The printed films of Examples 1 to 4 and Comparative Examples 1 and 2 were subjected to TOF-SIMS measurement at a temperature of −110° C., and I_{MAX} and I_{A}, explained below, were calculated. The I_{MAX}/I_{A} values of the printed films of Examples 1 to 4 were all in the range of 5 to 10, whereas those of Comparative Examples 1 and 2 were outside this range. The profiles of Example 1 and Comparative Example 1, obtained by the measurement are depicted in FIGS. 3 and 4, respectively.

I_{MAX}: the maximum intensity of the secondary ions derived from the organic solvents, measured in the thickness direction from the uppermost surface of the printed film; and

I_{A}: the average intensity of the secondary ions derived from the organic solvents measured in the thickness direction from the uppermost surface of the printed film in a period between 0.05×T_{MAX} and 0.50×T_{MAX} after the start of the measurement, wherein T_{MAX} represents the flight time of the secondary ions when the intensity of the secondary ions reaches Iₘₐₓ.

FIG. 3 is the profile obtained by the TOF-SIMS measurement of the printed film of Example 1, and FIG. 4 is the profile obtained by the TOF-SIMS measurement of the printed film of Comparative Example 1. The position of the peak in FIG. 3 represents the interface between the printed film and the OPP film, and the decreasing position in FIG. 4 represents the interface between the printed film and the OPP film.

### Wet Rub Resistance

The printed films were subjected to a test for color fastness to wet rubbing by being rubbed 100 times at a load of 200 g with a Gakushin-type rubbing tester AB-301S (a product manufactured by TESTER SANGYO). The degree of ink removal was examined in accordance with one of the Japanese Industrial Standards (JIS), JIS L 0849. Evaluation criteria are as presented below.

### Criteria

S: Wet 4 or greater

A: Wet ¾

B: Wet 3

C: Wet ⅔ or below

TABLE 2

| | | | | | Compar- | Compar- |
|---|---|---|---|---|---|---|
| | | | | | ative | ative |
| | Exam- | Exam- | Exam- | Exam- | Exam- | Exam- |
| | ple 1 | ple 2 | ple 3 | ple 4 | ple 1 | ple 2 |
| Wet rub | A | B | S | A | C | C |
| resistance | | | | | | |

Table 2 shows that the wet rub resistance of Examples 1 to 4, in which the pretreatment using the treatment liquid was performed, was increased compared to that of Comparative Examples 1 and 2, in which pretreatment was not performed.

1. A printed film formed on a surface of a non-water-absorbent or slightly water-absorbent printing medium and containing an organic solvent,
the printed film satisfying the following relationship (A):
5≤I_{MAX}/I_{A}≤10 (A)
where
I_{MAX}: maximum intensity of the secondary ions derived from the organic solvent, measured in the thickness direction from the uppermost surface of the printed film by time-of-flight secondary ion mass spectrometry; and
I_{A}: average intensity of the secondary ions derived from the organic solvent measured in the thickness direction from the uppermost surface of the printed film by time-of-flight secondary ion mass spectrometry in a period between 0.05×T_{MAX} and 0.50×T_{MAX} after the start of the measurement, wherein T_{MAX} represents the flight time of the secondary ions when the intensity of the secondary ions reaches Iₘₐₓ.

2. The printed film according to claim 1, wherein the non-water absorbent or slightly water-absorbent printing medium contains polypropylene as a main constituent.

3. The printed film according to claim 1, the printed film containing a urethane resin.

4. The printed film according to claim 1, the printed film containing an amino-containing polymer that contains an amino group.

5. The printed film according to claim 4, wherein the amino-containing polymer is polyethyleneimine.

6. The printed film according to claim 1, wherein the organic solvent is soluble in water.

7. A printing method, comprising:
a pretreatment step of applying a treatment liquid containing an amino-containing polymer containing an amino group onto a non-water-absorbent or slightly water-absorbent printing medium;
an ejection step of ejecting an ink composition containing an organic solvent, a coloring material, and a resin onto the printing medium having the treatment liquid applied thereto; and
a drying step of drying the printing medium having received the ink composition.

8. An ink set used for forming the printed film as set forth in claim 1, the ink set comprising:
a treatment liquid containing an amino-containing polymer that contains an amino group; and an ink composition containing an organic solvent, a coloring material, and a resin.

9. A printing method configured for printing by the printing method as set forth in claim 7.
